(19) United States
(12) Patent Application Publication
(10) Pub. No.: US 2006/0155606 A1
(43) Pub. Date: Jul. 13, 2006

(54) AUTOMATED COMPUTER-IMPLEMENTED METHOD AND SYSTEM FOR DETERMINING TAX DECISIONS

(75) Inventor: Phillip Simonte, Beverly Hills, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/905,594

(22) Filed: Jan. 12, 2005

(51) Int. Cl. G06Q 30/00

(52) U.S. Cl. 705/26

(57) ABSTRACT

An automated computer-implemented method for determining tax decisions is disclosed. The method includes receiving one or more tax registrations for identifying one or more suppliers, receiving one or more purchase orders, receiving an advanced shipping notice based on the one or more purchase orders and generating an invoice with an actual tax amount upon receipt of the advanced shipping notice.

### BACKGROUND OF THE INVENTION

1. Field of the Invention

One aspect of the present invention generally related to an automated computer-implemented method and system for determining tax decisions, and more specifically, to a method and system for determining tax decisions associated with global material purchases.

2. Background Art

International distributed enterprises, for example manufacturing enterprises, globally requisition suppliers for a tremendous amount of indirect and direct material in the operation of their business. Indirect and direct materials can refer goods and/or services. Direct materials refer to those that are needed for the product, whereas indirect materials support production of the product. For example, in the automotive industry, direct materials can be fenders, engine parts, transmission parts, manufacturing labor, etc. On the other hand, indirect materials can be pencils, paper, building heating and cooling, administrative labor, etc.

Due to the multitude of global transactions relating to material purchases, distributed enterprises have used the power of computers to implement systems that have functionality to handle purchasing, i.e. to generate purchase orders, and to receive goods and services, and accounts payable, i.e. to generate invoices on behalf of suppliers, and to pay suppliers. These computer systems also offer functionality for determining tax amounts for business transactions, although this functionality is not automated or integrated into the distributed enterprises other computer systems. The tax functionality does not allow suppliers to actively manage the determination of tax amounts.

For example, one proposal contemplates having suppliers calculate and send the tax to the manufacturer, who would manually add the invoice in a procurement module of a manufacturer computer system. This proposal has disadvantages, for example, the manufacturer would have to self-assess use taxes for direct pay locations in the United States (U.S.) and Canada. Alternatively, enterprise resource planning (ERP) solutions are available with limited tax decision functionality. However, these solutions do not have functionality to support global tax decisions for an accounts payable department in a distributed enterprise. There are also tax solutions for receivables, but they are not globally configured to handle both direct material and indirect material purchases.

In light of the foregoing, what is needed is an automated computer-implemented method and system for determining tax decisions associated with global material purchases. What is also needed is a method and system that allows supplier management of tax decision determination.

### SUMMARY OF THE INVENTION

One aspect of the present invention is an automated computer-implemented method and system for determining tax decisions associated with global material purchases. Another aspect of the present invention is a method for making tax decisions based on transactional level detail. According to another aspect, the manufacturer is not required to manually provide suppliers with direct pay permits and exemption certificates. In certain embodiments, the present invention also provides for automatic processing of supplier invoices. Advantageously, the data generated by the methods and systems of the present invention are available for audits. Certain embodiments of the present invention allow manufacturers and the manufacturer's suppliers to follow a common global taxation process. Moreover, the present invention can be used by tax experts to configure the tax decision to make accurate decisions based on the elements inputs. In certain embodiments, a decision engine is provided such that requisitioners, buyers, and suppliers define type of goods/services, commodity, how they are used, where they came from, and where they are performed or shipped.

According to a first embodiment of the present invention, an automated computer-implemented method for determining tax decisions is disclosed. The method includes receiving one or more tax registrations for identifying one or more suppliers, receiving one or more purchase orders, receiving an advanced shipping notice based on the one or more purchase orders, and generating an invoice with an actual tax amount and upon receipt of the advanced shipping notice. The method can further include receiving approval of the one or more purchase orders from a manufacturer. The method can further include generating a user interface for displaying the approved one or more purchase orders. The method can further include receiving a tax estimate based on the one or more tax registrations and the one or more purchase orders. The method can further include generating a self bill invoice. The method can further include generating a user interface for displaying the self bill invoice. The method can further include generating the advanced shipping notice. The advanced shipping notice can be generated by a supplier. The one or more purchase orders can each contain the following tax data elements: commodity code, end usage code, ship from location ship to location, place of service supply, quantity, price and delivery terms.

According to another embodiment of the present invention, a computer-implemented system for determining tax decisions is disclosed. The system includes one or more computers configured to receive one or more tax registrations for identifying one or more suppliers, receive one or more purchase orders, receive an advanced shipping notice based on the one or more purchase orders, and generate an invoice with an actual amount upon receipt of the advanced shipping notice. The one or more computers can be further configured to receive approval of the one or more purchase orders from a manufacturer. The one or more computers can be further configured to generate a user interface for displaying the approved one or more purchase orders. The one or more computers can be further configured to receive approval of shipment of goods or services described on the one or more purchase orders. The one or more computers can be further configured to generate a self bill invoice. The one or more computers can be further configured to generate a user interface for displaying the self bill invoice. The one or more computers can be further configured to receive a tax estimate based on the one or more tax registrations and the one or more purchase orders. The advanced shipping notice can be generated by a supplier. The one or more purchase orders can each contain the following tax data elements: commodity code, end usage code, ship from location ship to location, place of service supply, quantity, price and delivery terms.

According to yet another embodiment of the present invention, a computer-implemented apparatus for determining tax decisions is disclosed. The apparatus includes a means for receiving one or more tax registrations for identifying one or more suppliers, a means for receiving one or more purchase orders, a means for receiving an advanced shipping notice based on the one or more purchase orders, and a means for generating an invoice with an actual amount tax amount upon receipt of the advanced shipping notice.

According to yet another embodiment of the present invention, an automated computer-implemented method for determining tax decisions is disclosed. The method includes receiving one or more tax registrations for identifying one or more suppliers, receiving one or more purchase orders, receiving approval of the one or more purchase orders from a manufacturer, generating a user interface for displaying the approved one or more invoices, receiving a tax estimate based on the one or more tax registrations and the one or more purchase orders, receiving approval of shipment of goods or services described on the one or more purchase orders, receiving an advanced shipping notice based on the one or more purchase orders, generating an invoice with an actual tax amount upon receipt of the advanced shipping notice, and generating a self bill invoice.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompany drawings which:

FIG. 1 is a block diagram of the system architecture of a system according to one embodiment of the present invention; and

FIG. 2 is a process flowchart of the steps carried out by the automated tax decision engine according to one embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific functional details described herein are not to be interpreted as limiting, but merely as a representative basis for the claims and/or as a representative basis for teaching one of ordinary skill in the art to variously employ the present invention.

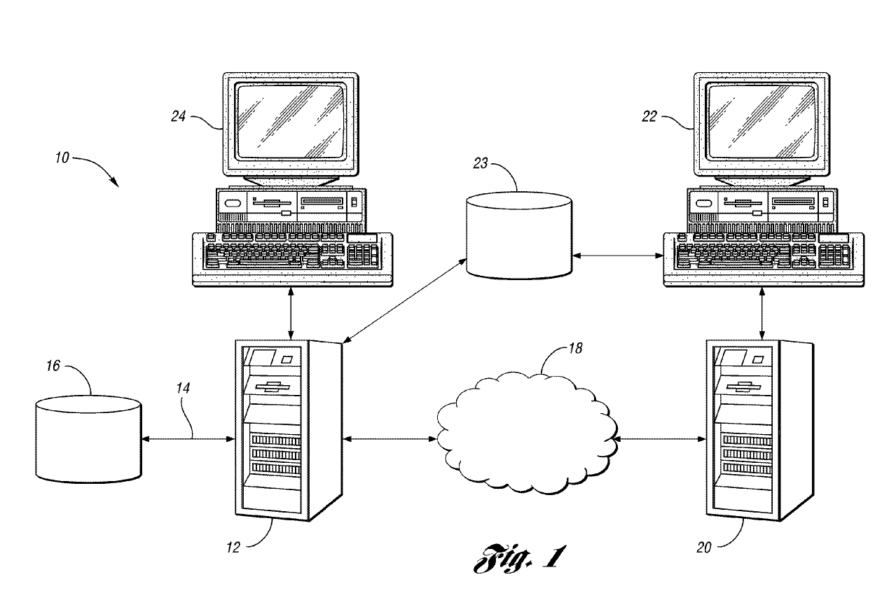

FIG. 1 is a block diagram illustrating overall system 10 for implementing one embodiment of the present invention. Overall system 10 includes purchaser server 12, which is connected through communication line 14 to database 16. Server 12 can transmit data to database 16 and can receive data from database 16. In certain embodiments, central server 12 includes a tax engine for determining tax decisions associated with global material purchases, as provided by the present invention. Server 12 can also include a procurement module having purchasing and accounts payable functionality. Purchaser server 12 is also connected via communication lines, for example the Internet 18, to supplier server 20, which can be used by suppliers for transmitting and receiving data relating to the tax decision determination process. Supplier server 20 also transmits and receives data from supplier user computer 22, which can display user interfaces for displaying information and receiving data pertaining to the tax decision determination process. Supplier user computer 22 can be utilized to input data, for example, tax registrations, point of origin, point of acceptance, into global supplier database 23. Data stored in global supplier database 23 can be transmitted to server 12 on a periodic basis, for example on a nightly basis. Purchaser server 12 transmits and receives data from purchaser user computer 24, which can display user interfaces for displaying information and receiving data pertaining to the tax decision determination process. Servers 12 and 20, database 16, and user computers 22 and 24 can be interconnected to a network, for example a local area network (LAN) or a wide area network (WAN), through a variety of interfaces, including, but not limited to dial-in connections, cable modems, high-speed lines, and hybrids thereof. Firewalls can be connected in any communication path to protect certain parts of the network from hostile and unauthorized use.

According to the embodiment depicted in FIG. 1, servers 12 and 20 and user computers 22 and 24 support TCP/IP protocol which has input and access capabilities via two-way communication lines.

The communication lines included in computer system 10 can be an intranet-adaptable communication line, for example, a dedicated line, a satellite link, an Ethernet link, a public telephone network, a private telephone network, and hybrids thereof. The communication lines can also be Intranet-adaptable. Examples of suitable communication lines include, but are not limited to, public telephone networks, public cable networks, and hybrids thereof.

According to the present invention, an automated computer-implemented tax decision determination process is disclosed. The implementation includes a global automated tax decision engine, which can reside on purchaser server 12. The global automated tax decision engine can be used to receive and utilize tax decision data elements, which can include, but are not limited to, direct pay permits, supplier tax registrations, ship from locations, ship to locations, bill to locations, bill from locations, service locations, commodity codes, end usage codes, point of origin, and point of acceptance.

Direct pay permits can refer to an agreement a purchaser has with a particular tax jurisdiction, which allows the purchaser to not pay sales taxes to the supplier. Supplier tax registrations can refer to a process, i.e. nexus, whereby a business is required to register the fact that it makes sales in a particular jurisdiction. A company that is registered is typically required to charge and account for tax in accordance with jurisdiction and country rules. Ship from location can refer to the supplier's site from which material is being shipped. Ship to location can refer to the location where a material is provided, i.e., delivered or shipped to. Bill to location can refer to location billing is sent to. Bill from location can refer to the supplier's site where billing is done. Service location can refer to the location where a service takes place. Commodity code can refer to a code that is used to define the category of a good or service. End usage code can refer to a code that can be used to define how a good is being used. The usage helps to decide whether it is taxable. For example, a computer used on a production line to manufacture a car may not be taxable while a computer used in an office is taxable. Point of origin can refer to the supplier's address or location where purchase orders are sent. Point of acceptance can refer to the supplier's address or location where purchase orders are accepted.

The engine provides functionality to allow suppliers to have input into the invoice tax decision and to review estimated purchase order tax decisions, thereby improving the accuracy of the invoice tax decision. In certain embodiments, the engine provides functionality to automatically create invoices based on receipts. These invoices can be paid according to supplier payment terms. The engine also provides functionality to base decisions on the transaction level data, providing a structure for tax planning, audit support, automated use tax accruals, and reporting.

The engine provides functionality to allow suppliers to enter and manage tax registrations using a database accessible online. The database can be database 16, as depicted in FIG. 1. When a purchase order is created in a manufacturer's procurement module, the engine calls a tax estimation system to provide a tax estimate. Tax estimation systems are available for estimating global taxes. Taxware is a commercial software product, available through Taxware, LP of Massachusetts, that can be used to determine taxes for United States (U.S.) and Canadian ship to locations. Other software products exist for estimating taxes for ship to locations of the European Union (E.U.), Mexico, and other non-U.S. countries. For example, U.S. Pat. App. Pub. No. 2004/0068452 discloses a method and system of computing estimated taxes at the time of purchase order and/or computing actual calculations at the time of invoice, which is incorporated herein in its entirety by reference. Inputs of ship to locations, ship from locations, bill to locations, bill from locations, service locations, etc. can be collected from purchase orders and transmitted to the engine. The estimated tax can be displayed in the supplier portal on supplier user computer 22, when the supplier views the purchase order. In certain embodiments, the supplier portal is a plurality of web forms for displaying purchase orders, invoices, shipping notices, etc.

After the supplier provides the good and services definition on the purchase order, they can submit an automated shipping notice (ASN). On the ASN, the supplier can correct some of the data elements, for example, the ship from, ship to, and place of service supply locations that may have changed since the time of the purchase order. The manufacturer then receives the goods/services and an automated invoice is created on behalf of the supplier. The tax is automatically determined and added to the invoice. Decisions are made to either pay the tax to the supplier or accrue taxes based on ship to locations, tax registrations, nexus, and direct pay permits. Nexus can refer to the “connection” or presence that is maintained in the state/locality that gives the tax jurisdiction the right to require tax collection. Nexus can be triggered, among other things, by soliciting business, owning property, leasing property or having employees residing in a jurisdiction. After the tax decision is made, a summary invoice can be created to document the details of the invoice and the tax decision. Suppliers are able to view the summary on the supplier portal or receive an electronic copy. Transactional level data detail is available via reports for audit support and tax returns. Purchase tax estimates are available for tax planning purposes and possible restructuring of the purchase order to achieve some tax saving benefits.

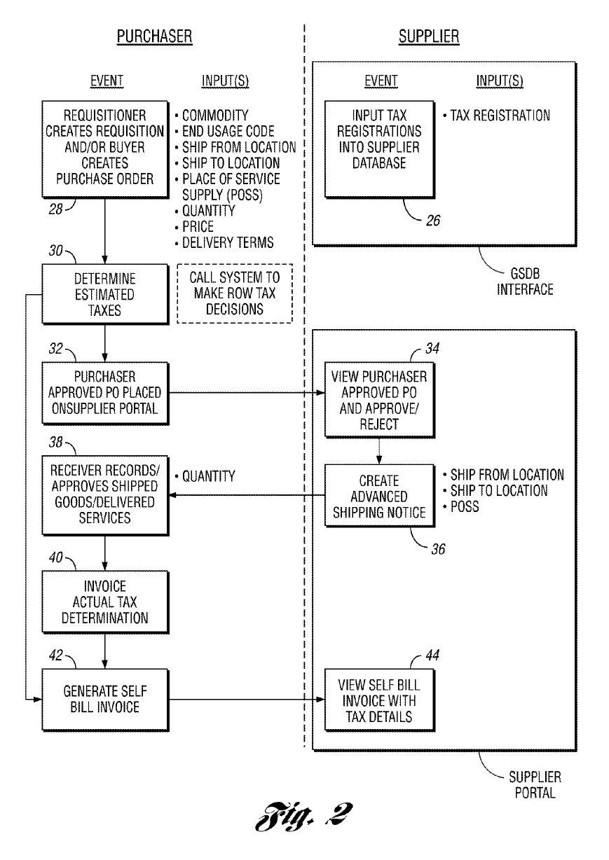

FIG. 2 is a process flowchart of the steps carried out by the automated tax decision engine according to one embodiment of the present invention. FIG. 2 also identifies the inputs provided by requisitioners, buyers, and suppliers according to this embodiment.

According to block 26, suppliers input value added tax (VAT) identifications (IDs) and U.S. sales tax registrations. In certain embodiments, this step occurs only once for each supplier site. New registration entries can be automatically interfaced from database 16 on a daily basis. In certain embodiments, VAT IDs are required for European and Mexican transactions. In certain embodiments, tax registrations are entered for European, Mexican, and Canadian VAT registrations, and U.S. sales tax registrations.

According to block 28, requisitioners and buyers enter the following tax data elements on requisitions and purchase orders in no particular order. Commodity code and subcode are entered, which describe the item being purchased. The sub code can further define the item being purchased for tax purposes. The code can be selected from a list of values in a drop down window in a purchase order item category field on a user interface. The subcode can be selected from a list of values in a drop down window in a purchase order item category field on a user interface. End usage code is entered, which describes how or where the item purchased is used by the manufacturer. The end usage code can impact U.S. and Canadian tax decisions and can be selected from a list of values. Ship from locations can be coded as a 5-digit code based on the supplier supplying the goods or services to the purchaser. This value can be selected from a list of values. Ship to locations are entered and can be a manufacturer or supplier 5-digit code based on the entity receiving the goods or services. This value can be selected from a list of values or entered on an advanced shipping notice (ASN) by the supplier. In certain embodiments, this value is required by the supplier on an ASN if the ship to location is unknown at the time of the purchase order generation. Place of service supply (POSS) is entered and describes the country where a service is being performed. In certain embodiments, the country of POSS is used in European tax decisions and Canadian withholding. Quantity is entered, and describes the number of items being purchased. Price is entered, and describes the price of the items being purchased. Delivery terms are entered, and describe the delivery terms on the purchase order. This value is used to determine whether ASN ship date or receipt is used in making the invoice, i.e. actual, tax decision.

According to block 30, tax estimates can be generated as the first step in the purchase order approval process. Estimates are included in the purchase order notification sent to approvers. The tax decision engine can call the tax estimate value when the purchase order is generated to verify that the required tax elements are available to make a tax decision at time of invoice. The tax decision engine can determine the estimated tax value in the first stage of the purchase order approval phase, i.e. at block 30.

According to block 32, after the tax estimate is successfully completed and the purchase order has gone through its approval chain, the purchase order becomes approved by the purchaser and is placed on the supplier portal for acceptance by its supplier.

According to block 34, the supplier views the purchase order using the supplier portal. The purchase order contains U.S. and Canadian direct pay permit numbers to inform suppliers when the manufacturer will remit sales/use tax directly to the taxing authorities. Estimated tax amounts are included for the suppliers to view and confirm based on tax element inputs.

According to block 36, the supplier completes the ASN and enters the actual ship from location on the ASN. The ship from location is selected from a list of all supplier 5-digit codes available. If the correct ship from site is not available, the supplier can select “other” and enter the country the goods where shipped from in the country of origin field. The supplier also enters the POSS or ship to code from a list of manufacturer and supplier locations. If the actual POSS/ship to site is not listed the supplier enters the country, address, city, state and zip/postal codes. In certain embodiments, ASNs are mandatory for suppliers. The ship from location is the actual ship from location entered by the supplier on the ASN.

The POSS can be the actual country the service was performed and is entered by the supplier on the ASN. The ship to location is the actual ship to location selected from a list of values or manually entered by the supplier on the ASN.

According to block 38, the requisitioner receives the goods shipped by the supplier. The requisitioner also enters to quantity and delivery to values. The quantity is the actual quantity of items received by the manufacturer. This quantity is received during electronic receipts settlement (ERS) process, and is used for the invoice tax decision. The deliver to location is the location where the goods or services were received. The tax decision engine calls for receipt deliver to location, or the ship to location, in that order, if no ASN Ship to location was entered.

According to block 40, the final automated tax calculation is made to determine the tax amount of the goods or services received by the manufacturer. The ASN ship from site, ASN ship to, ASN POSS, quantity received, and the receiving location (ship to) are used in the invoice tax calculation. The tax details are automatically added to the invoice and are displayed on the self bill invoice (SBI).

According to block 42, the SBI, containing the receipt, taxes, payment date, etc. is created.

According to block 44, the supplier receives the SBI, which includes the actual tax amounts and details.

While the best mode for carrying out the invention has been described in detail, those familiar with the art to which this invention relates will recognize various alternative designs and embodiments for practicing the invention as defined by the following claims.

What is claimed is:

1. An automated computer-implemented method for determining tax decisions, the method comprising:
receiving one or more tax registrations for identifying one or more suppliers;
receiving one or more purchase orders;
receiving an advanced shipping notice based on the one or more purchase orders; and
generating an invoice with an actual tax amount upon receipt of the advanced shipping notice.

2. The method of claim 1 further comprising receiving approval of the one or more purchase orders from a manufacturer.

3. The method of claim 2 further comprising generating a user interface for displaying the approved one or more purchase orders.

4. The method of claim 1 further comprising receiving a tax estimate based on the one or more tax registrations and the one or more purchase orders.

5. The method of claim 1 further comprising generating a self bill invoice.

6. The method of claim 5 further comprising generating a user interface for displaying the self bill invoice.

7. The method of claim 1 further comprising generating the advanced shipping notice.

8. The method of claim 7 wherein the advanced shipping notice is generated by a supplier.

9. The method of claim 1 wherein the one or more purchase orders each contain the following tax data elements: commodity code, end usage code, ship from location ship to location, place of service supply, quantity, price and delivery terms.

10. A computer-implemented system for determining tax decisions, the system including one or more computers, the one or more computers configured to:
receive one or more tax registrations for identifying one or more suppliers;
receive one or more purchase orders;
receive an advanced shipping notice based on the one or more purchase orders; and
generate an invoice with an actual amount upon receipt of the advanced shipping notice.

11. The system of claim 10 wherein the one or more computers are further configured to receive approval of the one or more purchase orders from a manufacturer.

12. The system of claim 11 wherein the one or more computers are further configured to generate a user interface for displaying the approved one or more purchase orders.

13. The system of claim 10 wherein the one or more computers are further configured to receive approval of shipment of goods or services described on the one or more purchase orders.

14. The system of claim 10 wherein the one or more computers are further configured to generate a self bill invoice.

15. The system of claim 14 wherein the one or more computers are further configured to generate a user interface for displaying the self bill invoice.

16. The system of claim 10 wherein the one or more computers are further configured to receive a tax estimate based on the one or more tax registrations and the one or more purchase orders.

17. The system of claim 14 wherein the advanced shipping notice is generated by a supplier.

18. The system of claim 10 wherein the one or more purchase orders each contain the following tax data elements: commodity code, end usage code, ship from location ship to location, place of service supply, quantity, price and delivery terms.

19. A computer-implemented apparatus for determining tax decisions, the apparatus comprising:
means for receiving one or more tax registrations for identifying one or more suppliers;
means for receiving one or more purchase orders;
means for receiving an advanced shipping notice based on the one or more purchase orders; and
means for generating an invoice with an actual tax amount upon receipt of the advanced shipping notice.

20. An automated computer-implemented method for determining tax decisions, the method comprising:
receiving one or more tax registrations for identifying one or more suppliers;
receiving one or more purchase orders;
receiving approval of the one or more purchase orders from a manufacturer;
generating a user interface for displaying the approved one or more invoices;
receiving a tax estimate based on the one or more tax registrations and the one or more purchase orders;
receiving approval of shipment of goods or services described on the one or more purchase orders;
receiving an advanced shipping notice based on the one or more purchase orders;
generating an invoice with an actual tax amount upon receipt of the advanced shipping notice; and
generating a self bill invoice.
